(19) United States
(12) Patent Application Publication
(10) Pub. No.: US 2018/0367818 A1
(43) Pub. Date: Dec. 20, 2018

(54) Block Partition Structure in Video Compression

(71) Applicant: Futurewei Technologies, Inc., Plano, TX (US)

(72) Inventors: Shan Liu, San Jose, CA (US); Shan Gao, Shenzhen (CN); Jiantong Zhou, Shenzhen (CN); Jiali Fu, Shenzhen (CN)

(21) Appl. No.: 16/000,620

(22) Filed: Jun. 5, 2018

Related U.S. Application Data
(60) Provisional application No. 62/520,414, filed on Jun. 15, 2017.

(51) Int. Cl. H04N 19/96; H04N 19/176; H04N 19/159; H04N 19/513; H04N 19/124

(52) U.S. Cl. CPC H04N 19/96; H04N 19/176; H04N 19/124; H04N 19/513; H04N 19/159

(57) ABSTRACT

A method of coding implemented by a decoding device. The method includes receiving a bitstream containing a picture from an encoding device, dividing the picture into coding tree units (CTUs), partitioning one of the CTUs into first sub-blocks using quad-tree (QT) partitioning, and partitioning the first sub-blocks into second sub-blocks using a first type of partitioning (e.g., BT or TT). Thereafter, partitioning of the second sub-blocks is restricted to only the first type of partitioning. An image generated using the one of the CTUs as partitioned is displayed on a display of an electronic device.

### CROSS-REFERENCE TO RELATED APPLICATIONS

This patent application claims the benefit of U.S. Provisional Patent Application No. 62/520,414, filed Jun. 15, 2017, by Shan Liu, et al., and titled “Block Partition Structure in Video Compression,” the teaching and disclosure of which is hereby incorporated in its entirety by reference thereto.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. With limited network resources and ever increasing demands of higher video quality, improved compression and decompression techniques that improve compression ratio with little to no sacrifice in image quality are desirable.

### SUMMARY

In an embodiment, the disclosure includes a method of coding implemented by a coding device. The method includes receiving, from an encoding device, a bitstream containing a picture; dividing the picture into coding tree units (CTUs); partitioning one of the CTUs into first sub-blocks using quad-tree partitioning; partitioning one of the first sub-blocks into second sub-blocks using a first type of partitioning; restricting partitioning of the second sub-blocks to the first type of partitioning after the one of the first sub-blocks has been partitioned using the first type of partitioning; and displaying, on a display of an electronic device, an image generated using the one of the CTUs as partitioned.

Optionally, in any of the preceding aspects, another implementation of the aspect provides that the first type of partitioning is binary-tree (BT) partitioning or triple-tree (TT) partitioning. Optionally, in any of the preceding aspects, another implementation of the aspect provides iteratively partitioning one of the second sub-blocks using the first type of partitioning until a predetermined threshold is reached for a leaf block, wherein the leaf block is used for prediction without any further partitioning. Optionally, in any of the preceding aspects, another implementation of the aspect provides that the leaf block is a coding unit (CU) or a coding block (CB). Optionally, in any of the preceding aspects, another implementation of the aspect provides that the bitstream contains a flag indicating that further partitioning of the second sub-blocks is restricted to only binary-tree (BT) partitioning. Optionally, in any of the preceding aspects, another implementation of the aspect provides that the flag is located in a sequence parameter set (SPS), a picture parameter set (PPS), or a slice header of the bitstream. Optionally, in any of the preceding aspects, another implementation of the aspect provides that the bitstream contains a flag indicating that the first type of partitioning is binary-tree (BT) partitioning or triple-tree (TT) partitioning.

In an embodiment, the disclosure includes a method of coding implemented by a coding device. The method includes receiving, from an encoding device, a bitstream containing a picture; dividing the picture into coding tree units (CTUs); partitioning one of the CTUs into first sub-blocks using quad-tree partitioning; iteratively partitioning one of the first sub-blocks using a first type of partitioning until a predetermined threshold is reached for a leaf block; and displaying, on a display of an electronic device, an image generated using the one of the CTUs as partitioned.

Optionally, in any of the preceding aspects, another implementation of the aspect provides that the first type of partitioning is binary-tree (BT) partitioning or triple-tree (TT) partitioning. Optionally, in any of the preceding aspects, another implementation of the aspect provides that the leaf block is used for prediction without any further partitioning. Optionally, in any of the preceding aspects, another implementation of the aspect provides that the predetermined threshold is a minimum allowed number of pixels. Optionally, in any of the preceding aspects, another implementation of the aspect provides that the predetermined threshold is a maximum allowed BT depth. Optionally, in any of the preceding aspects, another implementation of the aspect provides that the predetermined threshold is a minimum allowed coding unit (CU) area. Optionally, in any of the preceding aspects, another implementation of the aspect provides that the predetermined threshold is a minimum allowed number of pixels for a width of the leaf block. Optionally, in any of the preceding aspects, another implementation of the aspect provides that the predetermined threshold is a minimum allowed number of pixels for a height of the leaf block. Optionally, in any of the preceding aspects, another implementation of the aspect provides that the predetermined threshold is a minimum allowed number of pixels for a width and a height of the leaf block. Optionally, in any of the preceding aspects, another implementation of the aspect provides that the predetermined threshold is a minimum allowed ratio between a width and a height of the leaf block.

In an embodiment, the disclosure includes a decoding device. The decoding device includes a receiver configured to receive a bitstream from an encoding device, the bitstream including a picture; a memory storing instructions; and a processor coupled to the memory, the processor configured to execute the instructions stored in the memory to cause the processor to: divide the picture into coding tree units (CTUs); partition one of the CTUs into first sub-blocks using quad-tree partitioning; partition one of the first sub-blocks into second sub-blocks using a first type of partitioning; and restrict partitioning of the second sub-blocks to only the first type of partitioning after the one of the first sub-blocks has been partitioned using the first type of partitioning; and a display operably coupled to the processor, the display configured to display an image generated using the one of the CTUs as partitioned.

Optionally, in any of the preceding aspects, another implementation of the aspect provides that the first type of partitioning is binary-tree (BT) partitioning or triple-tree (TT) partitioning. Optionally, in any of the preceding aspects, another implementation of the aspect provides that the processor is configured to iteratively partition one of the second sub-blocks using the first type of partitioning until a predetermined threshold is reached for a leaf block, wherein the leaf block is used for prediction without any further partitioning.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustrating an example coding system that may utilize bi-lateral prediction techniques.

FIG. 2 is a block diagram illustrating an example video encoder that may implement bi-lateral prediction techniques.

FIG. 3 is a block diagram illustrating an example of a video decoder that may implement bi-lateral prediction techniques.

FIG. 4 is a coding tree unit (CTU) and a corresponding coding tree.

FIGS. 5A-C collectively illustrate a block (e.g., a CTU) subjected to one of the various partitioning types.

FIG. 6 is a CTU and a corresponding coding tree.

FIG. 7 is a CTU and a corresponding coding tree.

FIGS. 8A-E collectively illustrate a block subjected to one of the various partitioning types.

FIG. 9 illustrates an example signaling tree for signaling in multi-type-tree.

FIG. 10 is a flowchart illustrating an embodiment of a coding method.

FIG. 11 is a flowchart illustrating an embodiment of a coding method.

FIG. 12 is a schematic diagram of a network device.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

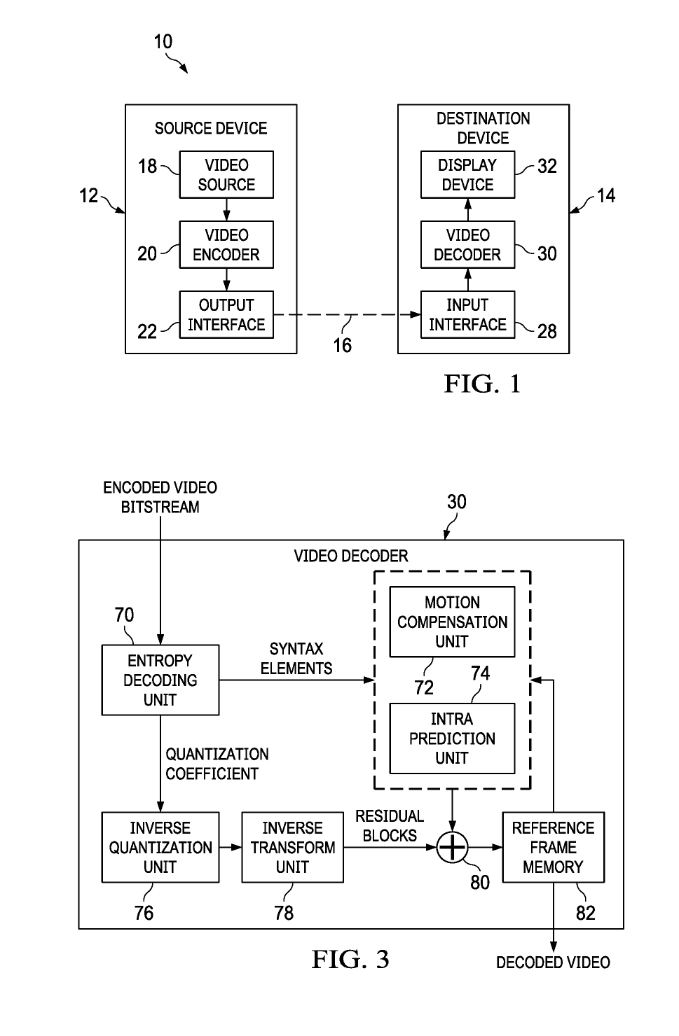

FIG. 1 is a block diagram illustrating an example coding system 10 that may utilize bidirectional prediction techniques. As shown in FIG. 1, the coding system 10 includes a source device 12 that provides encoded video data to be decoded at a later time by a destination device 14. In particular, the source device 12 may provide the video data to destination device 14 via a computer-readable medium 16. Source device 12 and destination device 14 may comprise any of a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, digital video disks (DVD)s, Compact Disc Read-Only Memories (CD-ROMs), flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), a file transfer protocol (FTP) server, network attached storage (NAS) devices, or a local disk drive. Destination device 14 may access the encoded video data through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, coding system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of the source device 12 and/or the video decoder 30 of the destination device 14 may be configured to apply the techniques for bidirectional prediction. In other examples, a source device and a destination device may include other components or arrangements. For example, source device 12 may receive video data from an external video source, such as an external camera. Likewise, destination device 14 may interface with an external display device, rather than including an integrated display device.

The illustrated coding system 10 of FIG. 1 is merely one example. Techniques for bidirectional prediction may be performed by any digital video encoding and/or decoding device. Although the techniques of this disclosure generally are performed by a video coding device, the techniques may also be performed by a video encoder/decoder, typically referred to as a “CODEC.” Moreover, the techniques of this disclosure may also be performed by a video preprocessor. The video encoder and/or the decoder may be a graphics processing unit (GPU) or a similar device.

Source device 12 and destination device 14 are merely examples of such coding devices in which source device 12 generates coded video data for transmission to destination device 14. In some examples, source device 12 and destination device 14 may operate in a substantially symmetrical manner such that each of the source and destination devices 12, 14 includes video encoding and decoding components. Hence, coding system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video.

In some cases, when video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., group of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the International Telecommunications Union Telecommunication Standardization Sector (ITU-T) H.264 standard, alternatively referred to as Motion Picture Expert Group (MPEG)-4, Part 10, Advanced Video Coding (AVC), H.265/HEVC, or extensions of such standards. The techniques of this disclosure, however, are not limited to any particular coding standard. Other examples of video coding standards include MPEG-2 and ITU-T H.263. Although not shown in FIG. 1, in some aspects, video encoder 20 and video decoder 30 may each be integrated with an audio encoder and decoder, and may include appropriate multiplexer-demultiplexer (MUX-DEMUX) units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

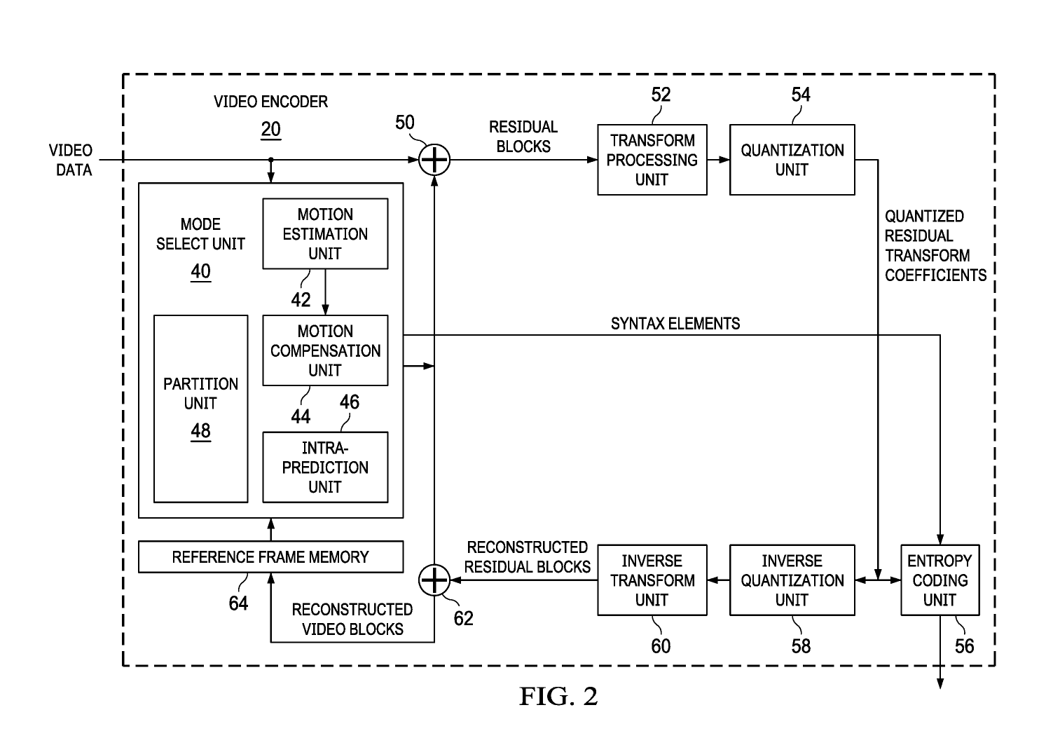

FIG. 2 is a block diagram illustrating an example of video encoder 20 that may implement bidirectional prediction techniques. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 2, video encoder 20 receives a current video block within a video frame to be encoded. In the example of FIG. 2, video encoder 20 includes mode select unit 40, reference frame memory 64, summer 50, transform processing unit 52, quantization unit 54, and entropy coding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into largest coding units (LCUs), and partition each of the LCUs into sub-coding units (sub-CUs) based on rate-distortion analysis (e.g., rate-distortion optimization). Mode select unit 40 may further produce a quad-tree data structure indicative of partitioning of a LCU into sub-CUs. Leaf-node CUs of the quad-tree may include one or more prediction units (PUs) and one or more transform units (TUs).

The present disclosure uses the term “block” to refer to any of a CU, PU, or TU, in the context of HEVC, or similar data structures in the context of other standards (e.g., macroblocks and sub-blocks thereof in H.264/AVC). A CU includes a coding node, PUs, and TUs associated with the coding node. A size of the CU corresponds to a size of the coding node and is square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quad-tree. A TU can be square or non-square (e.g., rectangular) in shape.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy coding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

In addition, intra-prediction unit 46 may be configured to code depth blocks of a depth map using a depth modeling mode (DMM). Mode select unit 40 may determine whether an available DMM mode produces better coding results than an intra-prediction mode and the other DMM modes, e.g., using rate-distortion optimization (RDO). Data for a texture image corresponding to a depth map may be stored in reference frame memory 64. Motion estimation unit 42 and motion compensation unit 44 may also be configured to inter-predict depth blocks of a depth map.

After selecting an intra-prediction mode for a block (e.g., a conventional intra-prediction mode or one of the DMM modes), intra-prediction unit 46 may provide information indicative of the selected intra-prediction mode for the block to entropy coding unit 56. Entropy coding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used.

Transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy coding unit 56 entropy codes the quantized transform coefficients. For example, entropy coding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy coding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

FIG. 3 is a block diagram illustrating an example of video decoder 30 that may implement bidirectional prediction techniques. In the example of FIG. 3, video decoder 30 includes an entropy decoding unit 70, motion compensation unit 72, intra-prediction unit 74, inverse quantization unit 76, inverse transformation unit 78, reference frame memory 82, and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of the video decoder 30 entropy decodes the bitstream to generate quantized coefficients, motion vectors or intra-prediction mode indicators, and other syntax elements. Entropy decoding unit 70 forwards the motion vectors and other syntax elements to motion compensation unit 72. Video decoder 30 may receive the syntax elements at the video slice level and/or the video block level.

When the video slice is coded as an intra-coded (I) slice, intra-prediction unit 74 may generate prediction data for a video block of the current video slice based on a signaled intra prediction mode and data from previously decoded blocks of the current frame or picture. When the video frame is coded as an inter-coded (e.g., B, P, or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Data for a texture image corresponding to a depth map may be stored in reference frame memory 82. Motion compensation unit 72 may also be configured to inter-predict depth blocks of a depth map.

As will be appreciated by those in the art, the coding system 10 of FIG. 1 is suitable for implementing block partition structure techniques.

In HEVC, a coding tree unit (CTU) consists of a luma coding tree block (CTB) and the corresponding chroma CTBs and syntax elements. These concepts are further defined in G. J. Sullivan, J.-R. Ohm, W.-J. Han, and T. Wiegand, “Overview of the High Efficiency Video Coding (HEVC) Standard”, IEEE Trans. Circuits and Systems for Video Technology, Vol. 22, No. 12, pp. 1649-1668, December 2012, which is incorpated herein by reference. The size L×L of a luma CTB can be chosen where L=16, 32, or 64 samples.

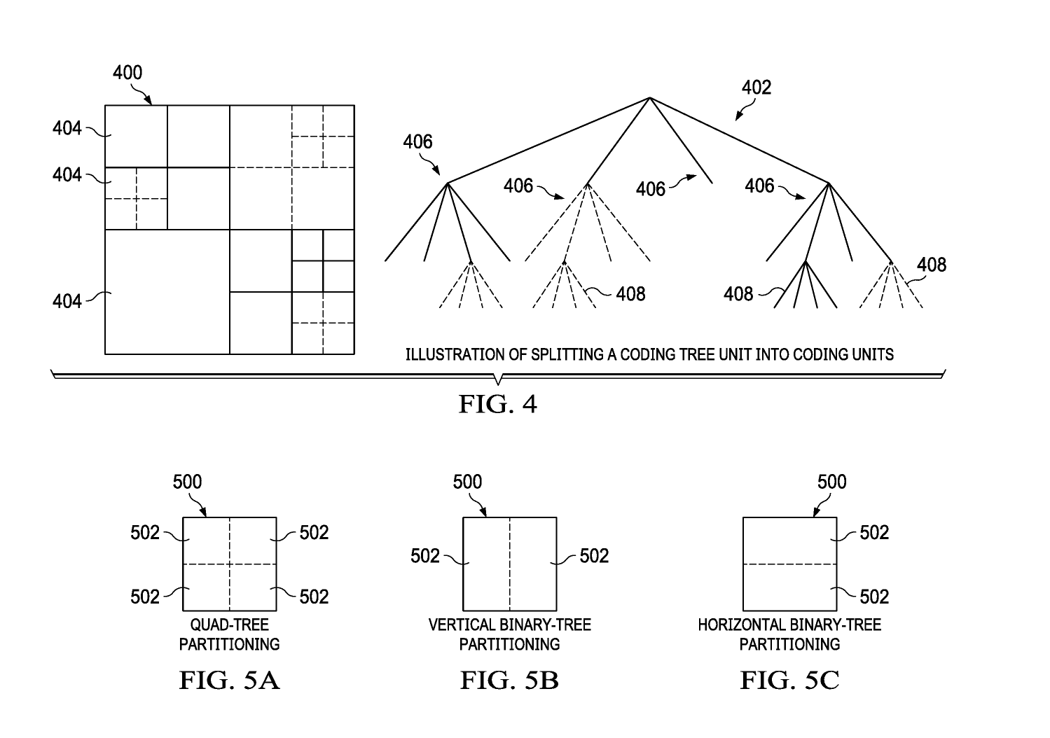

FIG. 4 illustrates a CTU 400 and a corresponding coding tree 402. As shown by both the CTU 400 and the coding tree 402, the CTU 400 has been split into various sub-blocks 404. In the embodiment of FIG. 4, the CTU 400 has been split using a quad-tree technique. However, in practical applications and as will be more fully explained below, other methods of splitting may be used. Also, despite the particular configuration of FIG. 4, it should be recognized that in some cases the CTU 400 can be a single coding unit (CU). In such cases, the CTU 400 has not been split.

The root of the quad-tree is associated with the CTU 400. As shown, the CTU 400 has been split into four smaller sub-blocks 404 (e.g., sub-units) of equal sizes of L/2×L/2, where L represents a length of the CTU 400. The sub-blocks 404 with the size of L/2 are represented on the coding tree 402 by nodes 406. The terms block and node represent a smaller unit or portion of the CTU and may be used interchangeably herein. The quad-tree splitting process is iterated until the size of a sub-block 404 reaches a minimum allowed coding unit (CU) size specified in the Sequence Parameter Set (SPS). When one of the sub-blocks 404 is not further split that sub-block may be referred to as a CU or one of the leaf nodes 408 (or leaf blocks) of the coding tree 402. In the coding tree 402 of FIG. 4, the solid lines indicate quad-tree splitting and the dotted lines indicate binary-tree splitting.

The decision whether to code a picture area using inter-picture (temporal) or intra-picture (spatial) prediction is made at the level of the CU. For each CU, there is an associated partitioning into prediction units (PUs) and a tree of transform units (TUs).

At the CTU 400 level, a flag (e.g., split_cu_flag) is used to indicate whether the complete CTU 400 represents a CU (e.g., the CTU has not been split) or whether the CTU 400 has been split into four equally-sized sub-blocks 404. If the CTU 400 has been split into sub-blocks 404, another split_cu_flag is transmitted to specify whether one or more of the sub-blocks 404 represent a CU or whether the sub-blocks 404 have been further split into four smaller equally-sized blocks.

In some cases, a quad-tree plus binary-tree (QTBT) block partitioning structure is used. Further details of the QTBT structure are found in the document “Block partitioning structure for next generation video coding,” J. An, et al., ITU-T SG16 Doc. COM16-C966, September 2015, which is incorporated herein by reference.

In the QTBT block partitioning structure, the root node of the quad-tree, which is a CTU or CTB, is first partitioned using quad-tree (e.g., first tree) partitioning to generate quad-tree leaf nodes. Each quad-tree leaf node can be iteratively split until the minimum allowed quad-tree leaf node size (MinQTSize) is reached. If the quad-tree leaf node size is not larger than the maximum allowed binary-tree root node size (MaxBTSize), each quad-tree leaf node can be further partitioned using a binary-tree (e.g., second tree) partitioning. The binary-tree splitting of a node can be iterated until the node reaches the minimum allowed binary-tree leaf node size (MinBTSize) or the maximum allowed binary-tree depth (MaxBTDepth). The binary-tree leaf node, which may be referred to as a CU (or coding block (CB)), will be used for prediction (e.g., intra-picture or inter-picture prediction) and transform without any further partitioning.

FIGS. 5A-C collectively illustrate a block 500 (e.g., a CTU) subjected to one of the various partitioning types discussed above. The block 500 in FIG. 5A has been quad-tree partitioned. As such, the block 500 has been split into four equally-sized sub-blocks 502. The blocks 500 in FIGS. 5B-C have been binary-tree partitioned. As such, the blocks have been split into two equally sized sub-blocks 502. For binary-tree splitting, there are two splitting types. FIG. 5B illustrates vertical binary-tree partitioning and FIG. 5C illustrates horizontal binary-tree partitioning. The various sub-blocks 502 may be further partitioned until the partitioning process is terminated.

Some blocks (e.g., the CTU of FIG. 4) are partitioned using various combinations of quad-tree and binary-tree partitioning, which is referred to as QTBT partitioning. In one example of the QTBT partitioning structure, the CTU size is set as 128×128 (representing luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quad-tree partitioning is applied to the CTU first to generate quad-tree leaf nodes. The quad-tree leaf nodes may have a size from 16×16 (e.g., the MinQTSize) to 128×128 (e.g., the CTU size). If the quad-tree leaf node is 128×128, it will not be further split by the binary-tree since the size exceeds the MaxBTSize (e.g., 64×64). Otherwise, the quad-tree leaf node will be further partitioned by the binary-tree. Therefore, the quad-tree leaf node is also the root node for the binary-tree and has the binary-tree depth as 0. When the binary-tree depth reaches MaxBTDepth (e.g., 4), it implies that no further splitting takes place. When the binary-tree node has a width equal to MinBTSize (e.g., 4), it implies no further horizontal splitting. Similarly, when the binary-tree node has height equal to MinBTSize, it implies no further vertical splitting. The binary-tree leaf nodes are namely CUs further processed by prediction and transform without any further partitioning.

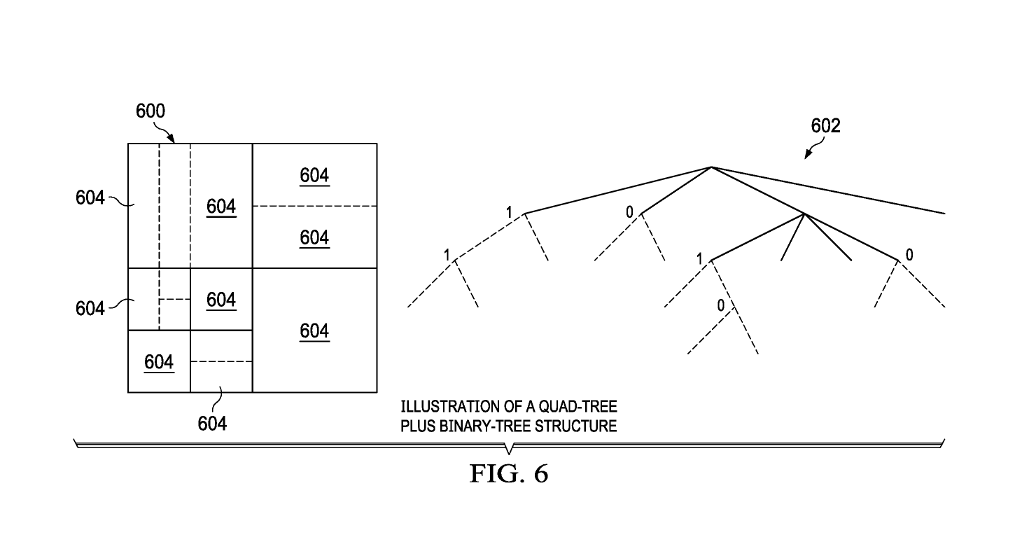

FIG. 6 illustrates a CTU 600 and a corresponding coding tree 602. As shown, the CTU 600 has been partitioned into various sub-blocks 604 using QTBT partitioning. In the coding tree 602, the solid lines indicate quad-tree splitting and the dotted lines indicate binary-tree splitting. In each splitting node of the binary-tree (e.g., non-leaf), a flag is signaled to indicate which splitting type (e.g., horizontal or vertical) is used. By way of example, the number “0” as shown in the coding tree 602 indicates a horizontal splitting and the number “1” indicates a vertical splitting. For the quad-tree splitting, there is no need to indicate the splitting type since the block is always split horizontally and vertically into four sub-blocks with an equal size.

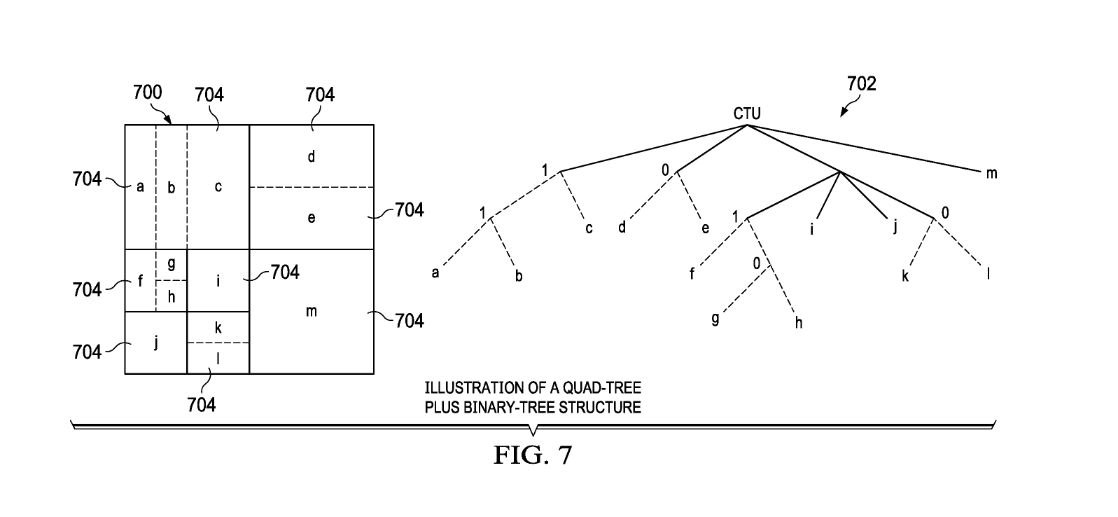

FIG. 7 illustrates a CTU 700 and a corresponding coding tree 702. As shown, the CTU 700 has been partitioned using QTBT partitioning. The CTU 700 of FIG. 7 has been split into thirteen CUs 704, which are labeled from “a” to “m” within the CTU 700. Each CU 704 has both a quad-tree depth (QTDepth) and a binary-tree depth (BTDepth) to indicate the type and number of splits. The QTDepth indicates the quad-tree depth of the quad-tree leaf block for the CU 704. The BTDepth indicates the binary-tree depth of the binary-leaf block for the CU 704. The quad-tree and binary-tree depths for the various CUs 704 in the CTU 700 are indicated below:
CU a, b: QTDepth is 1, BTDepth is 2;
CU c,d,e: QTDepth is 1, BTDepth is 1;
CU f,k,l: QTDepth is 2, BTDepth is 1;
CU i,j: QTDepth is 2, BTDepth is 0;
CU g,h: QTDepth is 2, BTDepth is 2;
CU m: QTDepth is 1, BTDepth is 0.

If a CTU such as CTU 700 was a single CU, its QTDepth and BTDepth are both 0.

In light of the above, it should be appreciated that the block partitioning structure (e.g., QTBT) denoted as the coding tree is used to partition the CTU into multiple CUs. For the I slice, a luma-chroma-separated block partitioning structure is used. The luma component of one CTU (e.g., the luma CTB) is partitioned by a QTBT blocking partitioning structure into luma CBs, and the two chroma components of that CTU (e.g., the two chroma CTBs) are partitioned by another QTBT blocking partitioning structure into chroma CBs. For the P and B slices, the block partitioning structure for luma and chroma is shared. That is, one CTU (including both luma and chroma) is partitioned by one QTBT block partitioning structure into CUs.

An example of the signaling that may be used for the partitioning described above is discussed further below.

For QTBT partitioning, a total of three bins are used for signaling. For a QT leaf, a first bin is signaled to indicate whether there is a QT split. If there is not, a second bin is signaled to indicate whether there is a BT split. If there is a BT split, a third bin is sent to indicate whether the split is a horizontal or vertical split.

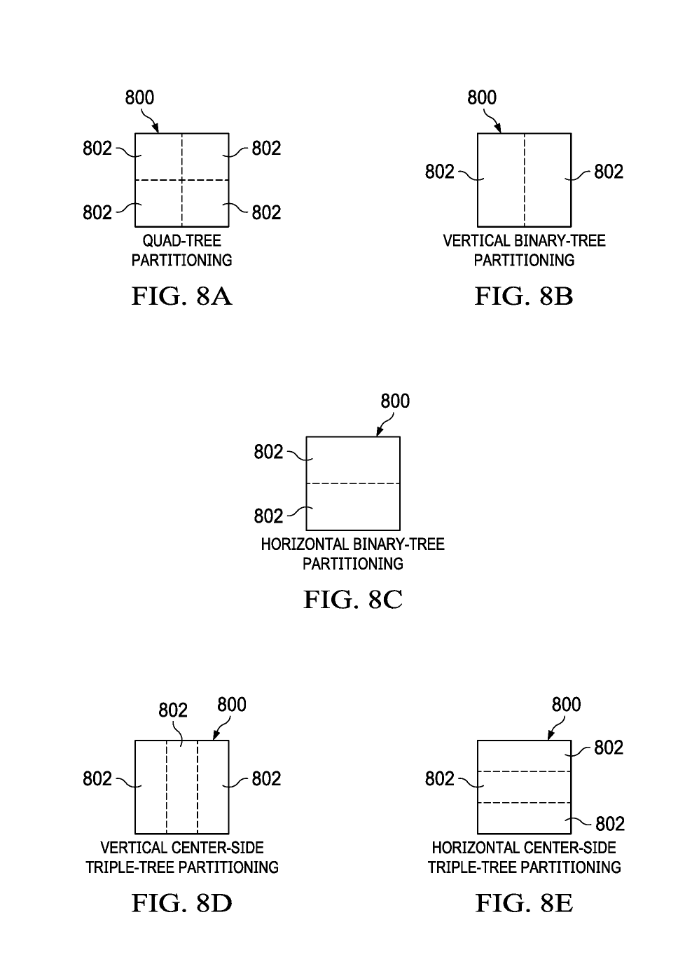

FIGS. 8A-C collectively illustrate a block 800 (e.g., CTUs) subjected to one of the various partitioning types. The block 800 in FIG. 8A has been quad-tree partitioned. As such, the block 800 has been split into four sub-blocks 802. The blocks 800 in FIGS. 8B-C have been binary-tree partitioned. As such, the blocks have been split into two sub-blocks 802. For binary-tree splitting, there are two splitting types. FIG. 8B illustrates vertical binary-tree partitioning and FIG. 8C illustrates horizontal binary-tree partitioning. Tree types other than quad-tree and binary-tree are supported. For example, vertical center-side triple-tree (TT) partitioning is shown in FIG. 8D, and horizontal center-side TT partitioning is shown in FIG. 8E.

Another type of partitioning is known as multi-type-tree (MTT). MTT is described in the document “Multi-Type-Tree,” by X. Li, et al., JVET-D0117, October 2016, which is incorporated herein by reference. In MTT, there are two levels of trees, region tree or first tree (e.g., quad-tree) and prediction tree or second tree (e.g., binary-tree or triple-tree). A CTU is first partitioned by region tree (RT). An RT leaf may be further split with prediction tree (PT). A PT leaf may also be further split with PT until the max PT depth is reached. A PT leaf is the basic coding unit. It is still called CU for convenience. A CU cannot be further split. Prediction and transform are both applied on CU.

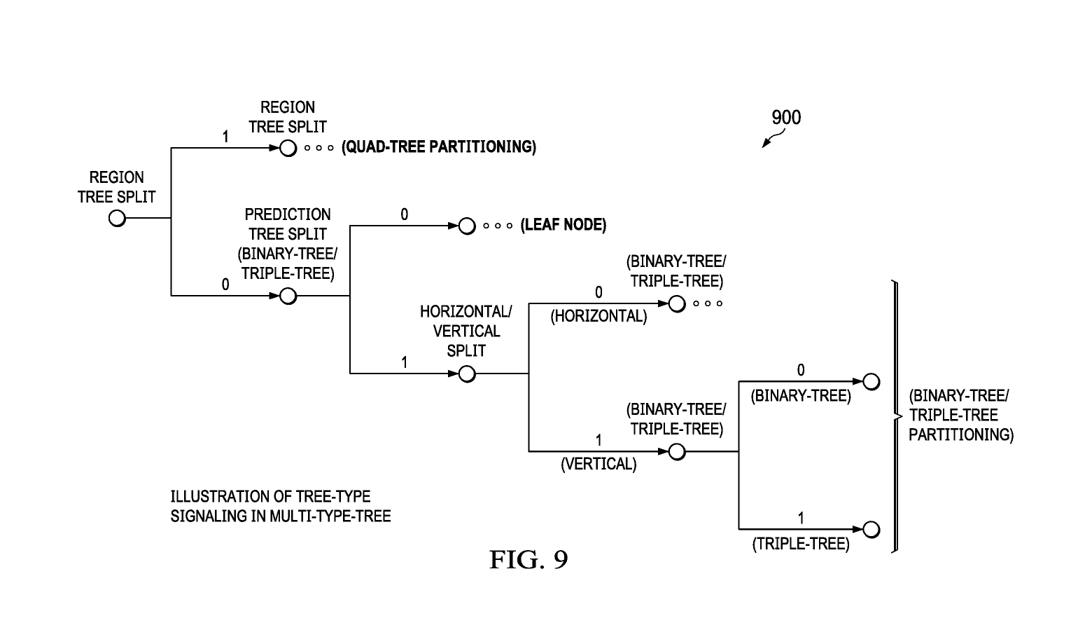

FIG. 9 illustrates an example signaling tree 900 for signaling in MTT. The signaling tree 900 includes, for example, RT and PT. RT signaling is similar to QT signaling. However, for PT signaling one additional bin is signaled to indicate whether the split is a binary-tree split or a triple-tree split. For an RT leaf, a first bin is signaled to indicate whether there is an RT split. If there is not an RT split, a second bin is signaled to indicate whether there is a PT split. If there is a PT split, a third bin is sent to indicate a horizontal or a vertical split. Then, a fourth bin is sent to distinguish between BT or TT partitioning. As shown in the signaling tree 900 of FIG. 9, a binary number (e.g., a 0 or a 1) may be used for the various signaling.

In existing methods, a CTU can be partitioned by using quad-tree, triple-tree, and binary-tree as described above. Disclosed herein are new coding tree designs for partitioning an image data. The coding tree designs provide numerous benefits including, for example, being able to signal the partitioning information using one less bin relative to conventional signaling techniques. Because fewer bins are used in the signaling process, the overall coding process is more efficient. In addition, fewer resources (e.g., bandwidth) are needed.

In a first method, a CTU (e.g., the CTU 700) is first partitioned by using quad-tree partitioning. In doing so, four sub-blocks (e.g., the CU 704 labeled “m” in FIG. 7) are formed. These sub-blocks, which may be referred to as quad-tree leaf nodes, are further partitioned using either triple-tree or binary-tree partitioning. When one of the sub-blocks is split using binary-tree partitioning, then each subsequent split for that sub-block is restricted to binary-tree partitioning. Likewise, when one of the sub-blocks is split using triple-tree partitioning, then each subsequent split for that sub-block is restricted to triple-tree partitioning. Thus, once one of the sub-blocks is split using one type of partitioning (e.g., either BT or TT), then further partitioning is restricted to that same type of partitioning. Partitioning in this manner is maintained or enforced until a sub-block generated by the partitioning meets a condition that qualifies that sub-block to be a binary-tree leaf node. A binary-tree leaf node is, for example, a CU (or CB) that will be used for prediction (e.g., intra-picture or inter-picture prediction) and transform without any further partitioning.

By using the above partitioning technique, the signaling of the partitioning is improved. Indeed, the signaling for conventional partitioning uses a four (4) bin method. A first bin is signaled to indicate whether there is a quad-tree split. If not, a second bin is signaled to indicate whether there is a triple or binary-tree split. If yes, a third bin is sent to indicate horizontal or vertical split. Then, a fourth bin is sent to distinguish between BT and TT partitioning.

In contrast, the signaling for the partitioning technique described is simplified. In an embodiment, a four (4) bin partitioning technique is used for non-binary-tree splitting, and a three (3) bin partitioning technique is used for binary-tree splitting. A first bin is signaled to indicate whether there is a quad-tree split. If not, a second bin is signaled to indicate whether there is a triple or binary-tree split. If yes, a third bin is sent to indicate either a horizontal or a vertical split. Then, a fourth bin is sent to distinguish between BT and TT partitioning. If the splitting of one node is using binary-tree, then the fourth bin does not need to be sent any longer because only binary-tree partitioning can be used for further partitioning.

In an embodiment, a five (5) bin partitioning technique is used. A first bin is signaled to indicate whether there is a quad-tree split. A second bin is signaled to indicate whether there is a triple-tree split. A third bin is sent to indicate either a horizontal or a vertical split. A fourth bin is signaled to indicate whether there is a binary-tree split. A fifth bin is sent to indicate either a horizontal or a vertical split.

Existing solutions first use quad-tree (e.g., first tree) followed by triple-tree or binary-tree (e.g., second tree) for block partitioning. In the second tree partition, triple-tree and binary-tree are always recursively used. Using the methods disclosed herein, the complexity of the encoder and/or decoder such as encoder 20 and decoder 30 is reduced relative to conventional encoders/decoders.

In a second method, the binary-tree splitting of a block (i.e., a node or sub-block) or the triple-tree splitting of a block may be iterated until the block reaches a threshold. In an embodiment, the second method is used in conjunction with the first method. However, the second method may also be used individually and apart from the first method. In an embodiment, the threshold may be any of the following:

The minimum allowed number of pixels of binary-tree leaf node;

The maximum allowed binary-tree depth;

The minimum allowed CU size;

The minimum allowed number of pixels for width;

The minimum allowed number of pixels for height;

The minimum allowed number of pixels between width and height; and

The minimum allowed ratio between width and height.

In an embodiment, threshold may be any of the following:

The minimum allowed number of pixels of leaf node (TH1);

The maximum allowed binary-tree depth (MaxBTDepth);

The maximum allowed second level tree depth (MaxSTDepth);

The minimum allowed number of pixels for binary-tree width (MaxBTWidth);

The minimum allowed number of pixels for binary-tree height (MaxBTHeight);

The maximum allowed number of pixels in leaf node (TH2). TH2 can be the same as TH1 or different.

The coding_binarytree syntax may follow the table below:

| | Descriptor |
|---|---|
| coding_binarytree( x0, y0, CuWidth, CuHeight, btDepth) { | |
| If( (btDepth < MaxSTDepth) \|\| (btDepth < MaxBTDepth) \|\| | |
| (CuWidth>MaxBTWidth) \|\| (CuHeight<MaxBTHeight) \|\| ( | |
| min(CuWidth,CuHeight)>TH1 ) \|\| ( | |
| max(CuWidth,CuHeight)<TH2 ) ) | |
| split_bt_flag[ x0 ][ y0 ] | ae(v) |
| ... | |
| if(split_bt_flag[ x0 ][ y0 ] ) { | |
| split_direction_flag | u(1) |
| ... | |
| if(!split_direction_flag){ | |
| y1 = y0 + ( 1 << ( log2CuHeight − 1 ) ) | |
| coding_binarytree( x0, y0, log2CuWidth, log2CuHeight − | |
| 1, btDepth+1) | |
| coding_binarytree ( x0, y1, log2CuWidth, log2CuHeight − | |
| 1, btDepth+1) | |
| } | |
| Else | |
| x1 = x0 + ( 1 << ( log2CuWidth − 1 ) ) | |
| coding_binarytree ( x0, y0, log2CuWidth − 1, | |
| log2CuHeight, btDepth+1) | |
| coding_binarytree ( x1, y0, log2CuWidth − 1, | |
| log2CuHeight, btDepth+1) | |
| } else | |
| coding_unit( x0, y0, log2CbSize ) | |
| } | |

In the table, split_bt_flag[x0][y0] specifies whether a coding unit is split into coding units with half horizontal or half vertical size. split_bt_flag[x0][y0] equal to 0 specifies that the coding unit is not split, and split_bt_flag[x0][y0] equal to 1 specifies that the coding unit is split into coding units with half horizontal or half vertical size.

split_direction_flag equal to 0 specifies that the coding unit is split into coding units with half horizontal size, and split_direction_flag equal to 1 specifies that the coding unit is split into coding units with half vertical size.

In a third method, a flag (e.g., named bt_leaf_node_mode) is used in the SPS, the picture parameter set (PPS), or the slice header to indicate whether a binary-tree leaf node mode is used. As used herein, the binary-tree leaf node mode means a mode in which a sub-block (e.g., node) is generated by binary-tree partitioning and is not further split.

At the SPS level, the binary-tree leaf node mode on/off control can be indicated in sequence level by using a flag in a general sequence parameter set raw byte sequence payload (RBSP) syntax, for example:

| | Descriptor |
|---|---|
| seq_parameter_set_rbsp( ) { | |
| .... | |
| sps_bt_leaf_node_flag | u(1) |
| ... | |
| } | |

where sps_bt_leaf_node_flag equal to 1 specifies that the sequence uses binary-tree leaf node mode, and sps_bt_leaf_node_flag equal to 0 specifies that the sequence does not use binary-tree leaf node mode.

At the PPS level, a picture parameter set range extension syntax may be used, for example:

| | Descriptor |
|---|---|
| pps_range_extension( ) { | |
| .... | |
| pps_bt_leaf_node_flag | u(1) |
| ... | |
| } | |

where pps_bt_leaf_node_flag equal to 1 specifies that the picture uses binary-tree leaf node mode; pps_bt_leaf_node_flag equal to 0 specifies that the picture does not use binary-tree leaf node mode.

In one embodiment, the usage of binary-tree leaf node mode should be signaled independently either in SPS level or PPS level, but not in both SPS and PPS level. For example, when sps_bt_leaf_node_flag is available, then pps_bt_leaf_node_flag is not present, vice versa.

In another embodiment, the usage of binary-tree leaf node mode may be signaled in both SPS and PPS level, with PPS signal overwriting SPS signal when they both exist.

At the slice level, the following syntax may be used:

| | Descriptor |
|---|---|
| slice_segment_header( ) { | |
| ... | |
| slice_bt_leaf_node_flag | u(1) |
| ... | |
| } | |

where slice_bt_leaf_node_flag equal to 1 specifies that the slice uses binary-tree leaf node mode, and slice_bt_leaf_node_flag equal to 0 specifies that the slice does not use binary-tree leaf node mode.

In a fourth method, a flag (e.g., named leaf_node_mode) is used in the SPS, the PPS, or the slice header to indicate whether the leaf node (e.g., either binary or triple) is a CU. That is, the flag is used to indicate the only type of partitioning that is allowed for the leaf node.

At the SPS level, the leaf_node_mode can be indicated in sequence level by using a flag in a general sequence parameter set RBSP syntax, for example:

| | Descriptor |
|---|---|
| seq_parameter_set_rbsp( ) { | |
| .... | |
| sps_leaf_node_mode | u(1) |
| ... | |
| } | |

where sps_leaf_node_mode equal to 0 specifies that the binary-tree is used at the leaf node in the sequence, and sps_leaf_node_mode equal to 1 specifies that the triple-tree splitting is used at the leaf node in the sequence.

At the PPS level, the splitting mode can be indicated in picture level by using a flag in a picture parameter set range extension syntax, for example:

| | Descriptor |
|---|---|
| pps_range_extension( ) { | |
| .... | |
| pps_leaf_node_mode | u(1) |
| ... | |
| } | |

where pps_leaf_node_mode equal to 0 specifies that the binary-tree splitting is used at the leaf node in the picture; pps_leaf_node_mode equal to 1 specifies that the triple-tree splitting is used at the leaf node in the picture.

In one embodiment, the usage of leaf_node_mode should be signaled independently either in SPS level or PPS level, but not in both SPS and PPS level. For example, when sps_leaf_node_mode is available, then pps_leaf_node_mode is not present, vice versa.

In another embodiment, the usage of leaf_node_mode may be signaled in both SPS and PPS level, with PPS signal overwrites SPS signal when they both exist.

At the slice level, the following syntax may be used:

| slice_segment_header( ) { | Descriptor |
|---|---|
| ... | |
| slice_leaf_node_mode | u(1) |
| ... | |
| } | |

where slice_leaf_node_mode equal to 0 specifies that the binary-tree splitting is used at the leaf node in the slice; slice_leaf_node_mode equal to 1 specifies that the triple-tree splitting is used at the leaf node in the slice.

Leaf node mode could be use between bt and tt, or bt and qt, or tt and qt.

Below is an embodiment of the encoder rate-distortion optimization (RDO) process of the quad-tree, triple-tree, and binary-tree (QT/TT/BT) blocking partitioning structure used to determine the best block partitioning. An example decision flow is provided below.

QTTTBT_RDO(x,y,width,height)
{
//try kinds of modes without any partitioning
TryInterPredMode(x,y,width,height);
TryIntraPredMode(x,y,width,height);
Save the cost of the best mode as CostNoPart;
//try the horizontal binary-tree partitioning
QTTTBT_RDO(x,y,width,height/2);
QTTTBT_RDO(x,y+height/2,width,height/2);
Save the cost of the best mode as CostHorBT;
//try the vertical binary-tree partitioning
QTTTBT_RDO(x,y,width/2,height);
QTTTBT_RDO(x+width/2,y,width/2,height);
Save the cost of the best mode as CostVerBT;
//try the horizontal triple-tree partitioning
QTTTBT_RDO(x,y,width,height/4);
QTTTBT_RDO(x,y+height/4,width,height/2);
QTTTBT_RDO(x,y+height*3/4,width,height/4);
Save the cost of the best mode as CostHorTT;
//try the vertical tripl tree partitioning
QTTTBT_RDO(x,y,width/4,height);
QTTTBT_RDO(x+width/4,y,width/2,height);
QTTTBT_RDO(x+width*3/4,y,width/4,height);
Save the cost of the best mode as CostVerTT;
//try the quad-tree partitioning
QTTTBT_RDO(x,y,width/2,height/2);
QTTTBT_RDO(x+width/2,y,width/2,height/2);
QTTTBT_RDO(x,y+height/2,width/2,height/2);
QTTTBT_RDO(x+width/2,y+height/2,width/2,height/2);
Save the cost as CostQT
//select the best cost to determinate the best block partitioning structure
CostBest = min(CostNoPart, CostHorTT, CostVerTT, CostHorBT,
CostVerBT, CostQT);
return;
}

For an input block, the function QTTTBT_RDO( ) is used to determine the best partition for encoder, and four input parameters are used as x, y, width, and height to indicate the x-coordinate and y-coordinate of the top-left position, width, and height of the block, respectively. At first, the input block is treated as a leaf node (e.g., CU or CB) of the coding tree to try all kinds of modes without any further partitioning for prediction and transform, and then the RD cost of the best mode is saved as CostNoPart. Second, all possible partitioning is tried according to a partitioning condition. Each splitting of the sub-block recursively calls the function QTTTBT_RDO( ) to determine their own best partitions. The cost of each partitioning is saved accordingly as CostHorBT, CostVerBT, CostHorTT, CostVerTT, CostQT. Next, the best blocking partitioning structure corresponding to the minimum cost is derived after making a comparison between CostHorBT, CostVerBT, CostHorTT, CostVerTT, and CostQT.

A fifth embodiment involves the use of the block partitioning structure as described herein for a luma sample and a chroma sample.

In this embodiment, a flag (e.g., named luma_chroma_coding_tree) is used in the SPS, the PPS, or the slice header to indicate whether the luma sample and the chroma sample use the same block partitioning structure or not. The flag can be used in one or more slice, including an I slice, a P slice, and a B slice.

At the SPS level, the leaf_node_mode can be indicated in the sequence level by using a flag in a general sequence parameter set RBSP syntax, for example:

| seq_parameter_set_rbsp( ) { | Descriptor |
|---|---|
| .... | |
| sps_same_luma_chroma_coding_tree | u(1) |
| ... | |
| } | |

where sps_same_luma_chroma_coding_tree equal to 0 specifies that the luma sample and the chroma sample use a different coding tree in the sequence, and sps_same_luma_chroma_coding_tree equal to 1 specifies that the luma sample and the chroma sample share the same coding tree in the sequence.

At the PPS level, the same_luma_chroma_coding_tree can be indicated in picture level by using a flag in a picture parameter set range extension syntax, for example:

| pps_range_extension( ) { | Descriptor |
|---|---|
| .... | |
| pps_same_luma_chroma_coding_tree | u(1) |
| ... | |
| } | |

where pps_same_luma_chroma_coding_tree equal to 0 specifies that the luma sample and the chroma sample use a different coding tree in the picture, and pps_same_luma_chroma_coding_tree equal to 1 specifies that the luma sample and the chroma sample share the same coding tree in the picture.

In one embodiment, the usage of same_luma_chroma_coding_tree should be signaled independently either in the SPS level or the PPS level, but not in both the SPS level and the PPS level. For example, when sps_leaf_node_mode is available, then pps_leaf_node_mode is not present, and vice versa.

In another embodiment, the usage of same_luma_chroma_coding_tree may be signaled in both the SPS and the PPS level, with the PPS signal overwriting the SPS signal when they both exist.

At the slice level, the following syntax may be used:

| slice_segment_header( ) { | Descriptor |
|---|---|
| ... | |
| slice_same_luma_chroma_coding_tree | u(1) |
| ... | |
| } | |

where slice same_luma_chroma_coding_tree equal to 0 specifies that the luma sample and the chroma sample use a different coding tree in the slice, and pps_same_luma_chroma_coding_tree equal to 1 specifies that the luma sample and the chroma sample share the same coding tree in the slice.

A sixth embodiment involves an indication of the first coding tree partition method.

In the sixth embodiment, a flag (e.g., named first_coding_tree_partition) is used in the SPS, the PPS, or the slice header to indicate which coding tree is first used, e.g., quad-tree, triple-tree, or binary-tree.

At the SPS level, the first_coding_tree_partition can be indicated in sequence level by using a flag in a general sequence parameter set RBSP syntax, for example:

| seq_parameter_set_rbsp( ) { | Descriptor |
|---|---|
| .... | |
| sps_first_coding_tree_partition | ae(v) |
| ... | |
| } | |

where sps_first_coding_tree_partition equal to 0 specifies that the quad-tree block partition is used first in the sequence, equal to 1 specifies that the triple-tree is used first in the sequence, and equal to 2 specifies that the binary-tree is used first in the sequence.

At the PPS level, the first_coding_tree_partition can be indicated in picture level by using a flag in a picture parameter set range extension syntax, for example:

| pps_range_extension( ) { | Descriptor |
|---|---|
| .... | |
| pps_first_coding_tree_partition | ae(v) |
| ... | |
| } | |

where pps_first_coding_tree_partition equal to 0 specifies that the quad-tree block partition is used first in the picture, equal to 1 specifies that the triple-tree is used first in the picture, and equal to 2 specifies that the binary-tree is used first in the picture.

In an embodiment, the usage of first_coding_tree_partition should be signaled independently either in the SPS level or the PPS level, but not in both the SPS level and the PPS level. For example, when sps_first_coding_tree_partition is available, then pps_first_coding_tree_partition is not present, and vice versa.

In an embodiment, the usage of first_coding_tree_partition may be signaled in both the SPS level and PPS level, with the PPS signal overwriting the SPS signal when they both exist.

At the slice level, the following syntax may be used:

| slice_segment_header( ) { | Descriptor |
|---|---|
| ... | |
| slice_first_coding_tree_partition | u(1) |
| ... | |
| } | |

where slice_first_coding_tree_partition equal to 0 specifies that the quad-tree block partition is used first in the slice, equal to 1 specifies that the triple-tree is used first in the slice, and equal to 2 specifies that the binary-tree is used first in the slice.

A seventh embodiment involves parameters for block partitioning that are used in the SPS, the PPS, or the slice header.

In this embodiment, at least one of the following parameters are used in the SPS, the PPS, or the slice header:

The maximum allowed triple-tree leaf node size;

The maximum allowed triple-tree leaf node size for luma samples;

The maximum allowed triple-tree leaf node size for chroma samples;

The maximum allowed triple-tree leaf node size for luma and chroma samples;

The maximum allowed triple-tree leaf node size for luma samples for I-slice;

The maximum allowed triple-tree leaf node size for chroma samples for I-slice;

The maximum allowed triple-tree leaf node size for luma and chroma samples for I-slice;

The maximum allowed triple-tree depth for luma samples;

The maximum allowed triple-tree depth for chroma samples;

The maximum allowed triple-tree depth for luma and chroma samples;

The maximum allowed triple-tree depth for luma samples for I-slice;

The maximum allowed triple-tree depth for chroma samples for I-slice;

The maximum allowed triple-tree depth for luma and chroma samples for I-slice;

The minimum allowed triple-tree leaf node size;

The minimum allowed triple-tree leaf node size for luma samples;

The minimum allowed triple-tree leaf node size for chroma samples;

The minimum allowed triple-tree leaf node size for luma and chroma samples;

The minimum allowed triple-tree leaf node size for luma samples for I-slice;

The minimum allowed triple-tree leaf node size for chroma samples for I-slice;

The minimum allowed triple-tree leaf node size for luma and chroma samples for I-slice.

| seq_parameter_set_rbsp( ) { | Descriptor |
|---|---|
| ... | |
| log2_min_luma_coding_tt_size_minus3 | ue(v) |
| log2_diff_max_min_luma_coding_tt_size | ue(v) |
| log2_min_chroma_coding_tt_size_minus3 | ue(v) |
| log2_diff_max_min_chroma_coding_tt_size | ue(v) |
| log2_min_intra_luma_coding_tt_size_minus3 | ue(v) |
| log2_diff_intra_max_min_luma_coding_tt_size | ue(v) |
| log2_min_inter_chroma_coding_tt_size_minus3 | ue(v) |
| log2_diff_inter_max_min_chroma_coding_tt_size | ue(v) |
| max_tt_depth_intra | ue(v) |
| max_tt_depth_inter | ue(v) |
| max_luma_coding_tt_depth | ue(v) |
| max_luma_coding_tt_depth | ue(v) |
| max_luma_coding_tt_depth_intra | ue(v) |
| max_luma_coding_tt_depth_inter | ue(v) |
| .... | |
| } | |

An eighth embodiment involves using the ratio of width over height.

In this embodiment, a parameter (e.g., named splitting_ratio_value_index) is used in the SPS, the PPS, or the slice header to indicate the split ratio of triple-tree, represented by using the ratio of width over height. Examples are shown below. One or more ratio values can be used dependently or independently. For a vertical split, the ratio is determined using width over height, and for a horizontal split, the ratio is determined using height over width.

| ratio index | ratio values of width over height |
|---|---|
| 0 | 1/4, 1/2, 1/4 |
| 1 | 1/8, 3/4, 1/8 |
| 2 | 1/4, 1/4, 1/2 |
| 3 | 1/8, 1/8, 3/8 |
| 4 | 1/2, 1/4, 1/4 |
| 5 | 3/8, 1/8, 1/8 |

In this embodiment, the splitting_ratio_value_index can be shown in the same level, or shown in different levels, as shown in the following examples.

At the SPS level, the splitting_ratio_value_index can be indicated in the sequence level by using a parameter in a general sequence parameter set RBSP syntax, for example:

| seq_parameter_set_rbsp( ) { | Descriptor |
|---|---|
| .... | |
| sps_splitting_ratio_value_index | ae(v) |
| ... | |
| } | |

where sps_splitting_ratio_value_index specifies the index of the splitting ratio value of triple-tree that is applied to the reconstructed pictures in the current sequence.

At the PPS level, the splitting_ratio_value_index can be indicated in picture level by using a flag in a picture parameter set range extension syntax, for example:

| pps_range_extension( ) { | Descriptor |
|---|---|
| .... | |
| pps_splitting_ratio_value_index | ae(v) |
| ... | |
| } | |

where pps_splitting_ratio_value_index specifies the index of the splitting ratio value of triple-tree that is applied to the reconstructed pictures in the current picture.

In an embodiment, the usage of splitting_ratio_value_index should be signaled independently either in the SPS level or the PPS level, but not in both the SPS level and the PPS level. For example, when sps_splitting_ratio_value_index is available, then pps_splitting_ratio_value_index is not present, and vice versa.

In an embodiment, the usage of splitting_ratio_value_index may be signaled in both the SPS and the PPS level, with the PPS signal overwriting the SPS signal when they both exist.

At the slice level, the following syntax may be used:

| slice_segment_header( ) { | Descriptor |
|---|---|
| ... | |
| slice_splitting_ratio_value_index | ae(v) |
| ... | |
| } | |

where slice_splitting_ratio_value_index specifies the index of the splitting ratio value of triple-tree that is applied to the reconstructed pictures in the current slice.

A ninth embodiment involves a same block partitioning constraint being used for the I-slice.

In this embodiment, a flag (e.g., named use_same_blk_partitioning_constraints) is used in the SPS, the PPS, or the slice header to indicate whether the I-slice and the non-I-slice use the same block partitioning constraints or not. The constraints could be the parameters/flag listed in aforementioned embodiments. If different block partitioning constraints are used for the I-slice and the non-I-slice, the corresponding constraint parameter will be indicated in the SPS, the PPS, or the slice header.

At the SPS level, the use_same_blk_partitioning_constraints can be indicated in sequence level by using a flag in a general sequence parameter set RBSP syntax, for example:

| seq_parameter_set_rbsp( ) { | Descriptor |
|---|---|
| .... | |
| sps_use_same_blk_partitioning_constraints | u(1) |
| if(sps_use_same_blk_partitioning_constraints) | |
| { | |
| Corresponding constraint parameters are indicated here | |
| } | |
| ... | |
| } | |

where sps_use_same_blk_partitioning_constraints equal to 0 specifies that the I-slice and the non-I-slice use different block partitioning constraints in the sequence, and sps_use_same_blk_partitioning_constraints equal to 1 specifies that the I-slice and the non-I-slice use the same block partitioning constraints in the sequence.

At the PPS level, the use_same_blk_partitioning_constraints can be indicated in picture level by using a flag in a picture parameter set range extension syntax, for example:

| pps_range_extension( ) { | Descriptor |
|---|---|
| .... | |
| pps_use_same_blk_partitioning_constraints | u(1) |
| if(sps_use_same_blk_partitioning_constraints) | |
| { | |
| Corresponding constraint parameters are indicated here | |
| } | |
| ... | |
| } | |

where pps_use_same_blk_partitioning_constraints equal to 0 specifies that the I-slice and the non-I-slice use different block partitioning constraints in the picture, and pps_use_same_blk_partitioning_constraints equal to 1 specifies that the I-slice and the non-I-slice use the same block partitioning constraints in the picture.

In an embodiment, the usage of use_same_blk_partitioning_constraints should be signaled independently either in the SPS level or the PPS level, but not in both the SPS level and the PPS level. For example, when sps_use_same_blk_partitioning_constraints is available, then pps_use_same_blk_partitioning_constraints is not present, and vice versa.

In an embodiment, the usage of use_same_blk_partitioning_constraints may be signaled in both the SPS level and the PPS level, with the PPS signal overwriting the SPS signal when they both exist.

At the slice level, the following syntax may be used:

| slice_segment_header( ) { | Descriptor |
|---|---|
| ... | |
| slice_use_same_blk_partitioning_constraints | u(1) |
| if(sps_use_same_blk_partitioning_constraints) | |
| { | |
| Corresponding constraint parameters are indicated here | |
| } | |
| ... | |
| } | |

where slice_use_same_blk_partitioning_constraints equal to 0 specifies that the I-slice and the non-I-slice use different block partitioning constraints in the slice, and slice_use_same_blk_partitioning_constraints equal to 1 specifies that the I-slice and the non-I-slice use the same block partitioning constraints in the slice.

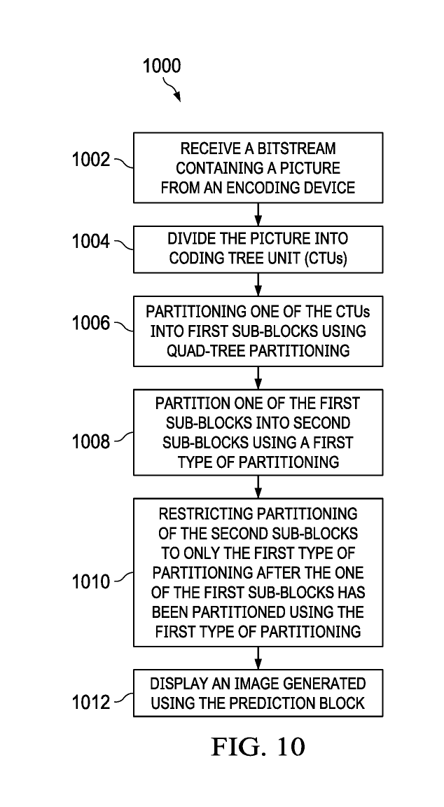

FIG. 10 is an embodiment of a method 1000 of coding implemented by a decoding device such as the decoder 30 of FIG. 3. The method 1000 is performed when more efficient video coding is desirable. While the method 1000 details steps performed in a decoding device, it should be recognized that one or more of the steps may also be implemented in an encoding device such as encoder 20 of FIG. 2.

In block 1002, a bitstream containing a picture (e.g., one image from a video) is received from an encoding device. In block 1004, the picture is divided into CTUs. In block 1006, one of the CTUs is partitioned into first sub-blocks using quad-tree partitioning. In block 1008, one of the first sub-blocks is partitioned into second sub-blocks using a first type of partitioning. The first type of partitioning may be, for example, BT or TT. In block 1010, partitioning of the second sub-blocks is restricted to only the first type of partitioning after the partitioning of the one of the first sub-blocks using the first type of partitioning. For example, if a first sub-block was partitioned using BT to generate second sub-blocks, then the second sub-blocks can only be partitioned using BT. In block 1012, an image generated using the one of the CTUs as partitioned is displayed on, for example, a display of an electronic device. If a method similar to method 1000 is implemented in an encoder, the final step may be signaling the CTUs as partitioned in a bitstream.

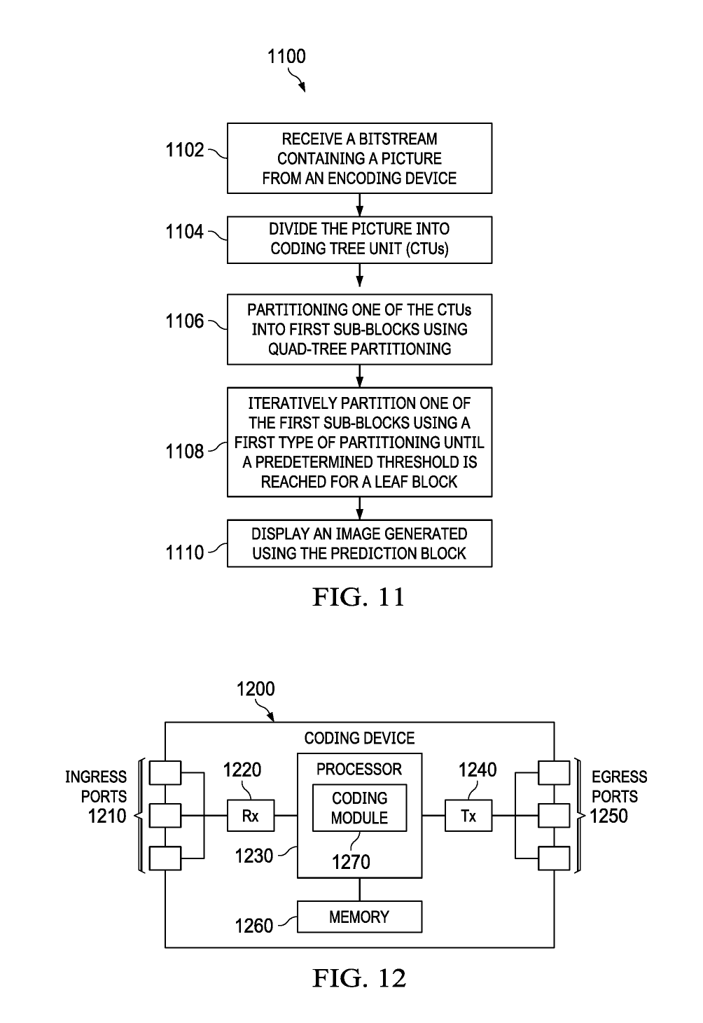

FIG. 11 is an embodiment of a method 1100 of coding implemented by a decoding device such as the decoder 30 of FIG. 3. The method 1100 is performed when more efficient video coding is desirable. While the method 1100 details steps performed in a decoding device, it should be recognized that one or more of the steps may also be implemented in an encoding device such as encoder 20 of FIG. 2.

In block 1102, a bitstream containing a picture (e.g., one image from a video) is received from an encoding device. In block 1104, the picture is divided into CTUs. In block 1106, one of the CTUs is partitioned into first sub-blocks using quad-tree partitioning. In block 1108, one of the first sub-blocks is iteratively partitioned using a first type of partitioning until a predetermined threshold is reached for a leaf block. The first type of partitioning may be, for example, BT or TT. In block 1110, an image generated using the one of the CTUs as partitioned is displayed on, for example, a display of an electronic device. If a method similar to method 1000 is implemented in an encoder, the final step may be signaling the CTUs as partitioned in a bitstream.

FIG. 12 is a schematic diagram of a coding device 1200 according to an embodiment of the disclosure. The coding device 1200 is suitable for implementing the disclosed embodiments as described herein. The coding device 1200 comprises ingress ports 1210 and receiver units (Rx) 1220 for receiving data; a processor, logic unit, or central processing unit (CPU) 1230 to process the data; transmitter units (Tx) 1240 and egress ports 1250 for transmitting the data; and a memory 1260 for storing the data. The coding device 1200 may also comprise optical-to-electrical (OE) components and electrical-to-optical (EO) components coupled to the ingress ports 1210, the receiver units 1220, the transmitter units 1240, and the egress ports 1250 for egress or ingress of optical or electrical signals.

The processor 1230 is implemented by hardware and software. The processor 1230 may be implemented as one or more CPU chips, cores (e.g., as a multi-core processor), field-programmable gate arrays (FPGAs), application specific integrated circuits (ASICs), and digital signal processors (DSPs). The processor 1230 is in communication with the ingress ports 1210, receiver units 1220, transmitter units 1240, egress ports 1250, and memory 1260. The processor 1230 comprises a coding module 1270. The coding module 1270 implements the disclosed embodiments described above. For instance, the coding module 1270 implements, processes, prepares, or provides the various coding operations. The inclusion of the coding module 1270 therefore provides a substantial improvement to the functionality of the coding device 1200 and effects a transformation of the coding device 1200 to a different state. Alternatively, the coding module 1270 is implemented as instructions stored in the memory 1260 and executed by the processor 1230.

The memory 1260 comprises one or more disks, tape drives, and solid-state drives and may be used as an over-flow data storage device, to store programs when such programs are selected for execution, and to store instructions and data that are read during program execution. The memory 1260 may be volatile and/or non-volatile and may be read-only memory (ROM), random access memory (RAM), ternary content-addressable memory (TCAM), and/or static random-access memory (SRAM).

A method of coding implemented by a decoding means, comprising: receiving, from an encoding means, a bitstream containing a picture; dividing the picture into coding tree units (CTUs); partitioning one of the CTUs into first sub-blocks using quad-tree partitioning;

partitioning one of the first sub-blocks into second sub-blocks using a first type of partitioning; restricting partitioning of the second sub-blocks to only the first type of partitioning after the one of the first sub-blocks has been partitioned using the first type of partitioning; and displaying, on a display means of an electronic means, an image generated using the one of the CTUs as partitioned.

A method of coding implemented by a decoding means, comprising: receiving, from an encoding means, a bitstream containing a picture; dividing the picture into coding tree units (CTUs); partitioning one of the CTUs into first sub-blocks using quad-tree partitioning; iteratively partitioning one of the first sub-blocks using a first type of partitioning until a predetermined threshold is reached for a leaf block; and displaying, on a display means of an electronic means, an image generated using the one of the CTUs as partitioned.

A decoding means, comprising: a receiving means configured to receive a bitstream from an encoding means, the bitstream including a picture; a memory means storing instructions; and a processing means coupled to the memory means, the processing means configured to execute the instructions stored in the memory memory to cause the processing means to: divide the picture into coding tree units (CTUs); partition one of the CTUs into first sub-blocks using quad-tree partitioning; partition one of the first sub-blocks into second sub-blocks using a first type of partitioning; and restrict partitioning of the second sub-blocks to only the first type of partitioning after the one of the first sub-blocks has been partitioned using the first type of partitioning; and a display means operably coupled to the processing means, the display means configured to display an image generated using the one of the CTUs as partitioned.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method of coding implemented by a decoding device, comprising:
receiving, from an encoding device, a bitstream containing a picture;
dividing the picture into coding tree units (CTUs);
partitioning one of the CTUs into first sub-blocks using quad-tree partitioning;
partitioning one of the first sub-blocks into second sub-blocks using a first type of partitioning;
restricting partitioning of the second sub-blocks to the first type of partitioning after the one of the first sub-blocks has been partitioned using the first type of partitioning; and
displaying, on a display of an electronic device, an image generated using the one of the CTUs as partitioned.

2. The method of claim 1, wherein the first type of partitioning is binary-tree (BT) partitioning or triple-tree (TT) partitioning.

3. The method of claim 1, further comprising iteratively partitioning one of the second sub-blocks using the first type of partitioning until a predetermined threshold is reached for a leaf block, wherein the leaf block is used for prediction without any further partitioning.

4. The method of claim 3, wherein the leaf block is a coding unit (CU) or a coding block (CB).

5. The method of claim 1, wherein the bitstream contains a flag indicating that further partitioning of the second sub-blocks is restricted to only binary-tree (BT) partitioning.

6. The method of claim 5, wherein the flag is located in a sequence parameter set (SPS), a picture parameter set (PPS), or a slice header of the bitstream.

7. The method of claim 1, wherein the bitstream contains a flag indicating that the first type of partitioning is binary-tree (BT) partitioning or triple-tree (TT) partitioning.

8. A method of coding implemented by a decoding device, comprising:
receiving, from an encoding device, a bitstream containing a picture;
dividing the picture into coding tree units (CTUs);
partitioning one of the CTUs into first sub-blocks using quad-tree partitioning;
iteratively partitioning one of the first sub-blocks using a first type of partitioning until a predetermined threshold is reached for a leaf block; and
displaying, on a display of an electronic device, an image generated using the one of the CTUs as partitioned.

9. The method of claim 8, wherein the first type of partitioning is binary-tree (BT) partitioning or triple-tree (TT) partitioning.

10. The method of claim 9, wherein the leaf block is used for prediction without any further partitioning.

11. The method of claim 9, wherein the predetermined threshold is a minimum allowed number of pixels.

12. The method of claim 9, wherein the predetermined threshold is a maximum allowed BT depth.

13. The method of claim 9, wherein the predetermined threshold is a minimum allowed coding unit (CU) area.

14. The method of claim 9, wherein the predetermined threshold is a minimum allowed number of pixels for a width of the leaf block.

15. The method of claim 9, wherein the predetermined threshold is a minimum allowed number of pixels for a height of the leaf block.

16. The method of claim 9, wherein the predetermined threshold is a minimum allowed number of pixels for a width and a height of the leaf block.

17. The method of claim 9, wherein the predetermined threshold is a minimum allowed ratio between a width and a height of the leaf block.

18. A decoding device, comprising:
a receiver configured to receive a bitstream from an encoding device, the bitstream including a picture;
a memory storing instructions; and
a processor coupled to the memory, the processor configured to execute the instructions stored in the memory to cause the processor to:
divide the picture into coding tree units (CTUs);
partition one of the CTUs into first sub-blocks using quad-tree partitioning;
partition one of the first sub-blocks into second sub-blocks using a first type of partitioning; and
restrict partitioning of the second sub-blocks to only the first type of partitioning after the one of the first sub-blocks has been partitioned using the first type of partitioning; and
a display operably coupled to the processor, the display configured to display an image generated using the one of the CTUs as partitioned.

19. The decoding device claim 18, wherein the first type of partitioning is binary-tree (BT) partitioning or triple-tree (TT) partitioning.

20. The decoding device claim 18, wherein the processor is configured to iteratively partition one of the second sub-blocks using the first type of partitioning until a predetermined threshold is reached for a leaf block, wherein the leaf block is used for prediction without any further partitioning.
